(19) United States
(12) Patent Application Publication
(10) Pub. No.: US 2011/0179901 A1
(43) Pub. Date: Jul. 28, 2011

(54) STEERING WHEEL SPINNER WITH INTERCHANGEABLE NOVELTY HELMET

(76) Inventor: Burkley U. KLADDE, Chandler, AZ (US)

(21) Appl. No.: 12/693,107

(22) Filed: Jan. 25, 2010

(51) Int. Cl. G05G 1/10

(52) U.S. Cl. 74/557

(57) ABSTRACT

A novelty helmet mounting device carried by a receiving element is disclosed. The novelty helmet mounting device has a novelty helmet mounting portion which mates with and engages a novelty helmet in an interference fit such that the novelty helmet mounting portion is adapted to receive and interchange multiple novelty helmets. The novelty helmet mounting portion is adapted to non-permanently retain the novelty helmet and has a protrusion that supports a portion of the novelty helmet against compression while the novelty helmet is grasped during use of the steering wheel spinner assembly. A steering wheel spinner assembly is also disclosed.

### SCOPE OF THE INVENTION

The present invention relates to steering wheel spinners, and in particular, a steering wheel spinner assembly that may be used with a novelty device.

### BACKGROUND

Attachments for a steering wheel, such as those that facilitate turning the steering wheel are known. Steering wheel spinner assemblies are used on a variety of steering wheels in a variety of vehicles. The assemblies generally have a structure connecting a rotatable knob to the steering wheel. The rotatable knob rotates in position on the steering wheel and may be grasped by an operator and used to rotate the steering wheel.

Novelty devices, including novelty devices used to decorate a vehicle, are also known. Such novelty devices are often constructed for decorative purposes only, and do not withstand the wear and tear of a functional component, such as a steering wheel or spinner assembly. Further, when a novelty device is constructed for a functional purpose, it is often restrictive in how it can be used.

Accordingly, a steering wheel spinner assembly that is adapted to receive an interchangeable novelty helmet is provided.

### SUMMARY OF THE INVENTION

A novelty helmet mounting device carried by a receiving element is disclosed. The novelty helmet mounting device has a novelty helmet mounting portion which mates with and engages a novelty helmet in an interference fit such that the novelty helmet mounting portion is adapted to receive and interchange multiple novelty helmets. The novelty helmet mounting portion has a protrusion adapted to non-permanently retain the novelty helmet and support a portion of the novelty helmet against compression while the novelty helmet is grasped during use of the steering wheel spinner assembly.

A steering wheel spinner assembly is also disclosed having a steering wheel clamp assembly including a clamp and a receiving element. A novelty helmet mounting device is carried by the receiving element such that the novelty helmet mounting device may freely rotate about a central axis extending along the receiving element. The novelty helmet mounting device has a novelty helmet mounting portion which mates with and engages a novelty helmet in an interference fit.

A novelty helmet mounting device and steering wheel spinner assembly according to the foregoing provides various advantages over traditional steering wheel spinner assemblies and novelty devices. In particular, the steering wheel spinner assembly incorporates geometric features that enable a commonly available product, namely, a novelty helmet, which may otherwise by unsuitable for use in a steering wheel spinner application due to a lack of structural capacity, to be installed onto the helmet mount of the spinner and serve as the spinning knob portion of the assembly. As the engagement and securement of the novelty helmet to the helmet mount is an interference fit, the novelty helmet is sufficiently secured to retain the helmet in place on the helmet mount during operation, but is not permanent and does not require modification of the novelty helmet to install. Furthermore, the helmet mount is formed to support a load or otherwise resist compression force placed upon the attached novelty helmet, thereby securing an otherwise fragile or semi-fragile device. The steering wheel spinner assembly further permits novelty helmets to be interchanged so that different helmets may be may be used with the assembly. The steering wheel spinner assembly described herein provides for the releasable attachment of a novelty helmet, allowing an operator to customize the device.

### BRIEF DESCRIPTION OF THE DRAWINGS

FIG. 1 is a perspective view of a steering wheel spinner assembly with interchangeable novelty helmet.

FIG. 2 is a perspective view of the steering wheel spinner assembly with interchangeable novelty helmet of FIG. 1 attached to a steering wheel, the steering wheel being shown in dash lines.

FIG. 3 is a partially exploded view of the steering wheel spinner assembly with interchangeable novelty helmet shown in FIG. 1, showing the separation of the novelty helmet from the helmet mount and the separation of a portion of the steering wheel clamp assembly.

FIG. 4 is a partially exploded view of the steering wheel spinner assembly with interchangeable novelty helmet shown in FIG. 1, showing the separation of the novelty helmet from the helmet mount and the separation of a portion of the steering wheel clamp assembly.

FIG. 5 is a partially exploded view of the steering wheel spinner assembly shown in FIG. 1, without interchangeable novelty helmet.

FIG. 6 is a partially exploded view of the steering wheel spinner assembly shown in FIG. 1, without interchangeable novelty helmet, taken along line 6-6 of FIG. 5.

FIG. 7 is a cross-section view of the steering wheel spinner assembly with interchangeable novelty helmet shown in FIG. 1, taken from line 7-7 of FIG. 1.

FIG. 8 is a cross-section view of the steering wheel spinner assembly with interchangeable novelty helmet shown in FIG. 1, taken from line 8-8 of FIG. 1.

FIG. 9 is a cross-section view of the steering wheel spinner assembly with interchangeable novelty helmet shown in FIG. 1, taken from line 9-9 of FIG. 1.

FIG. 10 is a perspective view of a novelty helmet for use with the steering wheel spinner assembly shown in FIG. 1.

FIG. 11 is a side elevation view of the steering wheel spinner assembly with interchangeable novelty helmet of FIG. 1, showing the novelty helmet separated from the helmet mount in a first position of the method of mounting said novelty helmet on the helmet mount.

FIG. 12 is a side elevation view of the steering wheel spinner assembly with interchangeable novelty helmet of FIG. 1, showing the novelty helmet mounted on the helmet mount in a second position of the method of mounting said novelty helmet on the helmet mount, showing the facemask partially disengaged from the novelty helmet.

FIG. 13 is a side elevation view of the steering wheel spinner assembly with interchangeable novelty helmet of FIG. 1, showing the novelty helmet mounted on the helmet mount in the method of mounting said novelty helmet on the helmet mount with the facemask engaged.

### DESCRIPTION OF THE INVENTION

The invention is generally directed to a steering wheel spinner assembly with an interchangeable novelty helmet 20. More specifically, the invention includes a steering wheel spinner assembly 22 forming a novelty helmet mounting device which is adapted to receive or carries a novelty device, such as a novelty helmet 24.

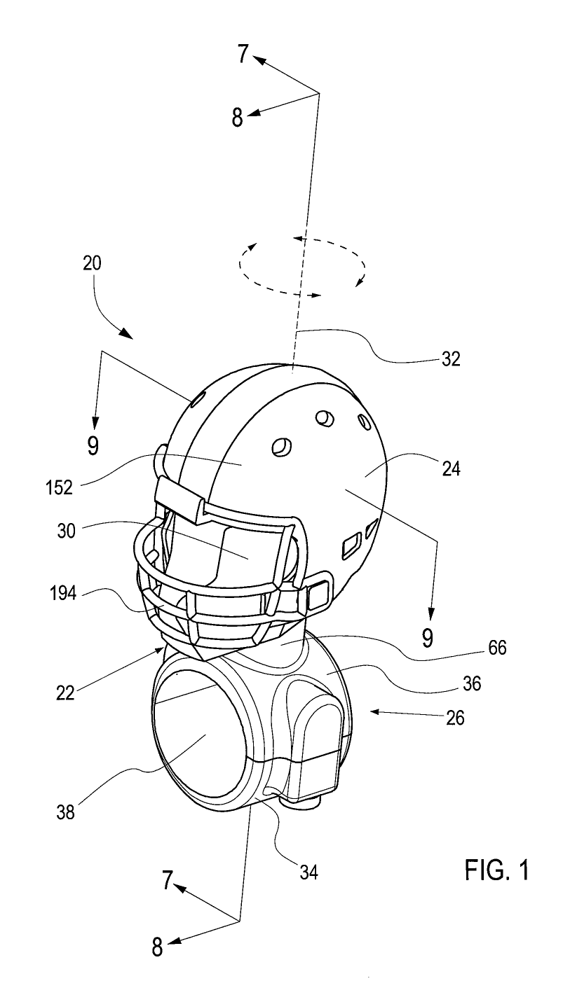

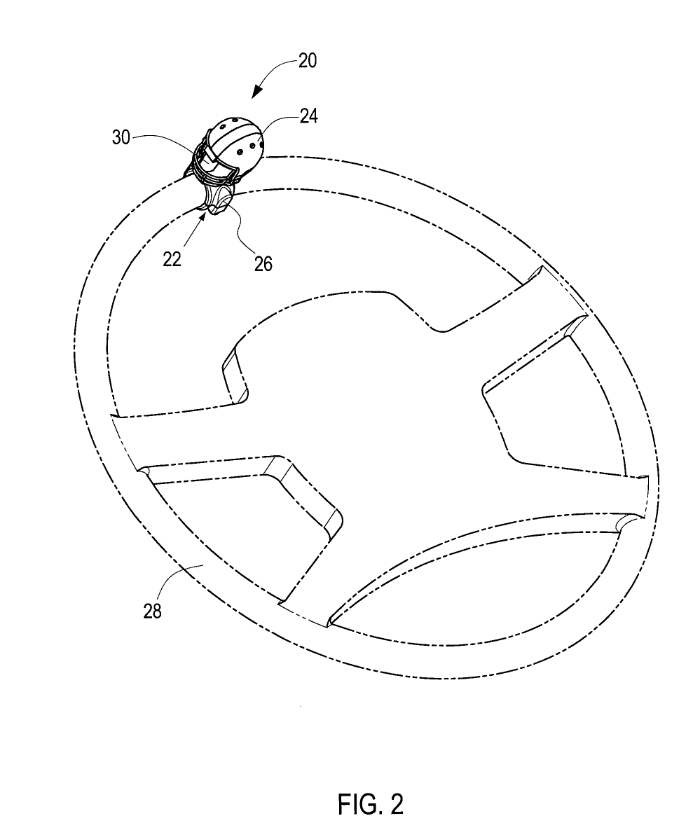

The steering wheel spinner assembly 22 shown in FIGS. 1 & 2 generally includes a clamp or clamp assembly 26 that is adapted to attach to or be carried by a steering wheel 28 (FIG. 2). The steering wheel spinner assembly 22 also includes a helmet mount 30 which is carried by the clamp 26. The helmet mount 30 carries a novelty helmet 24. The steering wheel spinner assembly 22 is adapted to allow rotational movement of the helmet mount 30, and novelty helmet 24 carried thereby about an axis 32.

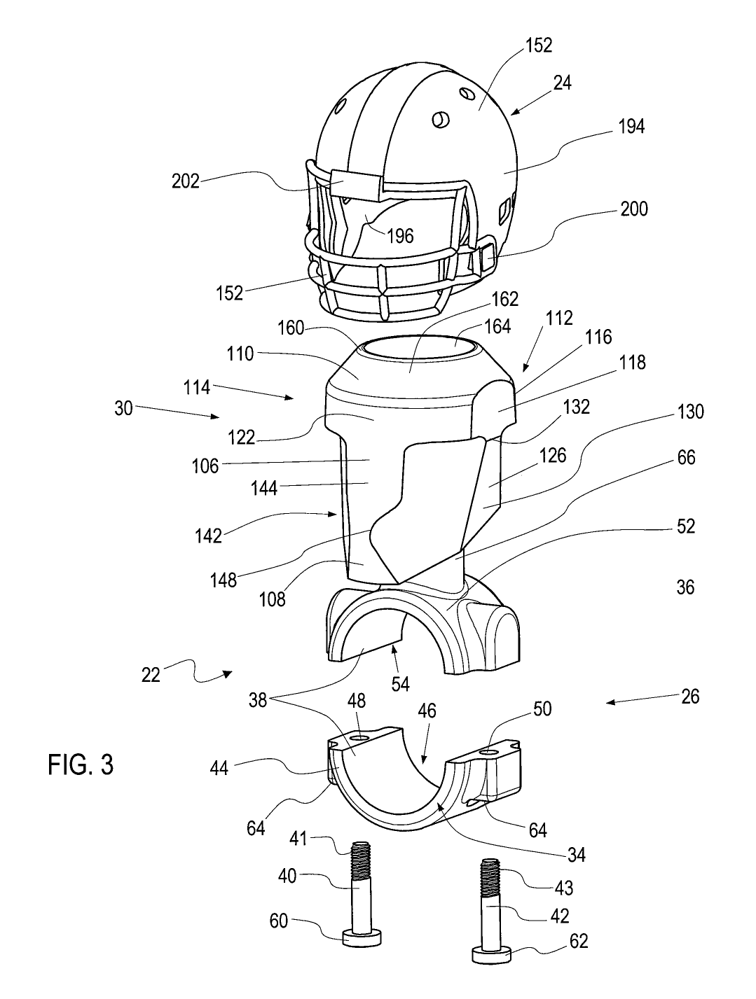

The clamp assembly 26 or steering wheel attachment assembly, as shown in FIGS. 3 & 4, is formed by a lower clamp arm 34 and an upper clamp arm 36 which form a steering wheel mating surface 38. The steering wheel clamp assembly 26 may be formed of a rigid material of sufficient strength to support a lateral load placed upon the assembly by a user who may pull up on or push upon the assembly. The steering wheel clamp assembly 26 is preferably formed of metal, and more preferably aluminum or stainless steel, although alternative metals or materials would not depart from the overall scope of the present invention. The steering wheel clamp assembly 26 or portions thereof may also be cast with secondary machining. The steering wheel mating surface 38 closely approximates the dimension of the steering wheel 28 to which it is attached so as to be rigidly secured to the wheel in a manner which resists or prevents movement of the clamp assembly 26 thereon. The clamp arms 34, 36 are linked or otherwise engaged or connected together by one or more fasteners 40, 42 permitting the clamp arms can be drawn and secured together. The lower clamp arm 34 has a housing 44 which includes a recess 46 adapted to receive the steering wheel 28. The recess 46 may be arcuate in shape and may be shaped to correspond in form to the geometry of a steering wheel 28, such as for example the inclusion of finger detents or grips. The lower clamp housing 44 also includes one or more apertures or receptors 48, 50 for one or more fasteners 40, 42. In FIG. 3, two apertures 48, 50 are provided to receive two fasteners 40, 42. The apertures 48, 50 extend through the housing 44, flanking the recess 46, but alternative locations may also be acceptable for the purposes provided.

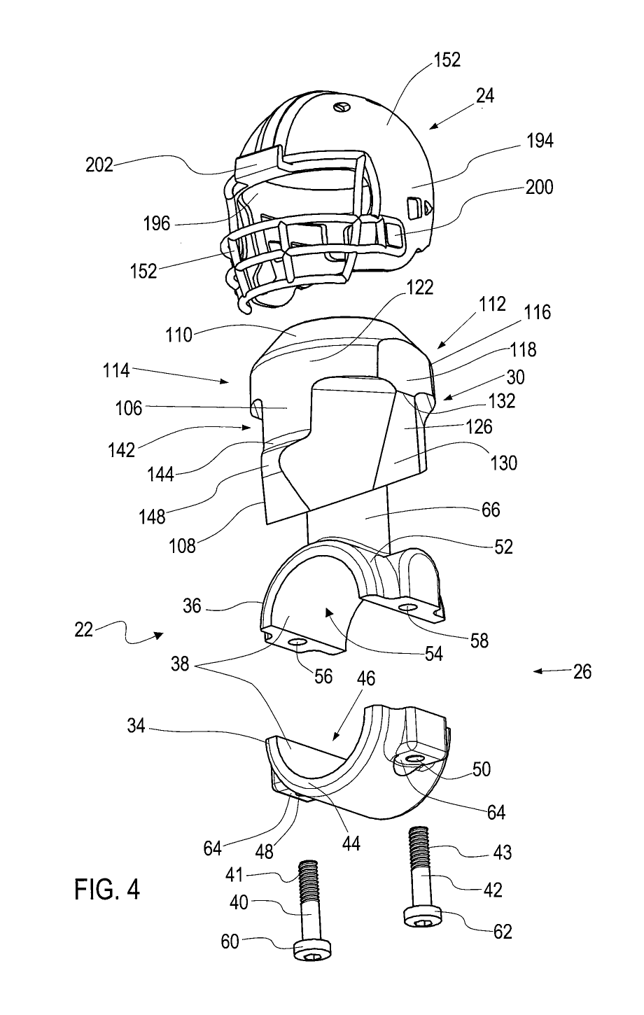

The upper clamp arm 36 has a housing 52 which is adapted to receive the steering wheel 28. Similar to the lower clamp arm 34, the upper clamp arm housing 52 shown in FIGS. 3 & 4 has a recess 54 which may be arcuate in shape or may be shaped to correspond in form to the geometry of the steering wheel 28. The upper clamp arm housing 52 also may include a receptor or aperture 56, 58, or more than one aperture, for receiving one or more fasteners 40, 42. Two apertures 56, 58 are illustrated in FIG. 4 in the upper clamp arm housing 52 for receipt of two fasteners 40, 42. The receptor 56, 58 in the upper clamp arm housing 52 may further include an inner thread 57, 59 or ring (see FIG. 8) to receive and secure the fastener 40, 42 in place in the receptor.

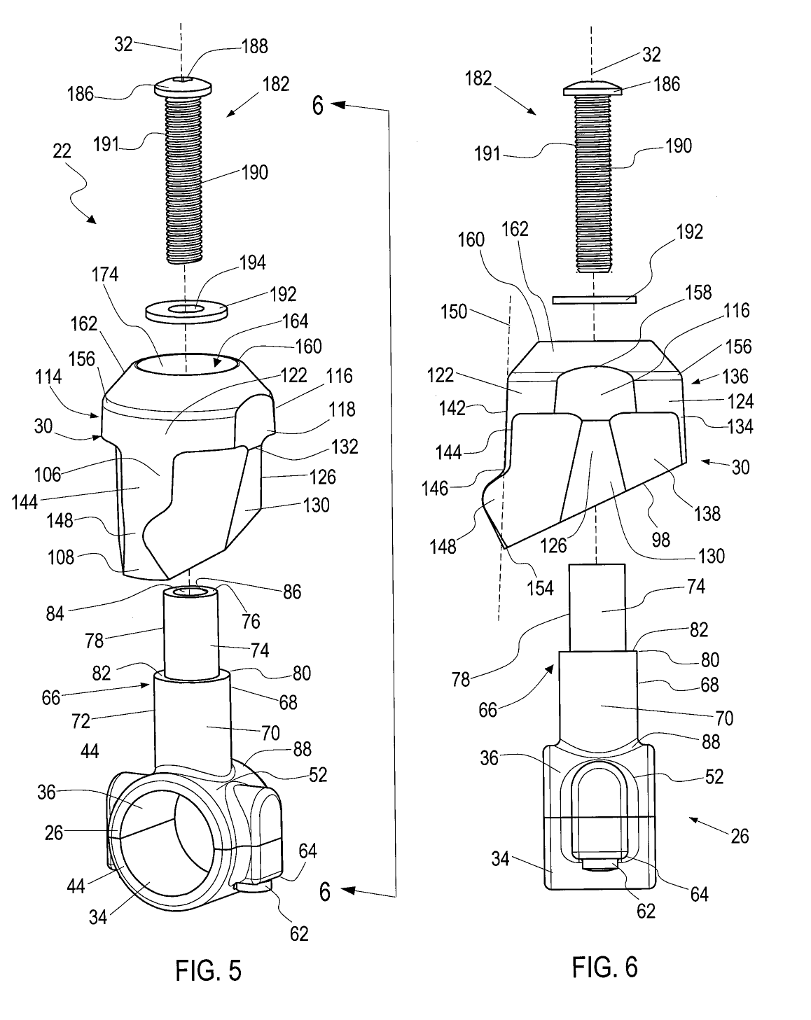

The fasteners 40, 42 shown in FIGS. 3-4 are bolts or screws. While a bolt or screw is illustrated in the figures, the fasteners 40, 42 may be clamps, tongue and groove-type devices, snap rings, buckles, or otherwise adapted to rigidly secure the upper and lower clamp arm housings 52, 44 together. The fasteners 40, 42 (shown in FIG. 3) may have a mating thread 41, 43 or other structure, including but not limited to a ring, groove, or other surface adapted to mate with a corresponding structure in the aperture. Fasteners 40, 42, also have a head 60, 62 which is adapted to rest on an outer surface 64 of the lower clamp arm housing 44 (see FIG. 5). The head 60, 62 may have a tool engaging portion (not shown) for operationally engaging the fastener 40, 42, such as a wrench, screw driver, or other suitable tool. In position on the clamp assembly 26, a fastener 40, 42 extends through the aperture 48, 50 in the lower clamp arm 34 and into the receptor 56, 58 on the upper clamp arm 36.

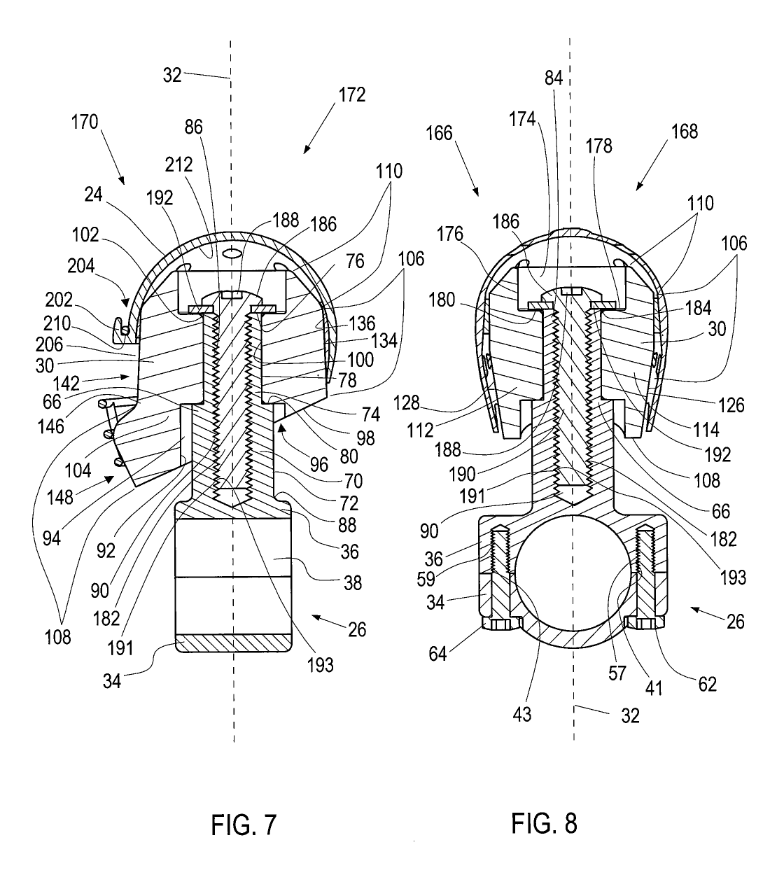

The upper clamp arm housing 52 may further include or have attached thereto a helmet mount engaging member 66. The helmet mount engaging member 66, shown in FIGS. 5 through 8, forms a neck or receiving element which is adapted to receive the helmet mount 30 and allow the helmet mount 30 to rotate thereon. To this end, the helmet mount engaging member 66 is formed by a structure having an outer cylindrical surface 68 extending from the housing 52 and surrounding a central axis 32. The helmet mount engaging member 66 shown in FIGS. 5 through 8 has a first segment 70 adjacent the housing 52 with an outer surface 70 of a first outer diameter, and a second segment 74 adjacent the first segment 70 including a free end 76, and further having an outer surface 78 of a second outer diameter which is smaller than the outer diameter of the first segment outer surface 72. Segment 70 may have a diameter ranging from 0.100 to 1.0 inch and more preferably is approximately 0.700 inch. Segment 74 may have a diameter ranging from 0.100 to 1.000 inch and more preferably is approximately 0.499 inch. The variation in diameter of the first and second segments forms a shoulder 80 having an upwardly facing surface 82. The size of shoulder 80 corresponds to the working diameter and shoulder size of a commercially available composite plastic shoulder bushing for a 0.500 in diameter shaft. As shown in FIGS. 5, 7 & 8, the helmet mount engaging member 66 has an aperture or opening 84 on the free end 76 and extending along the length of the helmet mount engaging member 66 to the upper clamp arm housing 52. The aperture 84 has an inner surface 86 which may be an inner cylindrical surface. In FIGS. 7& 8, the inner cylindrical surface 86 is of a constant diameter extending the entire length or depth of the aperture. The inner cylindrical surface may be threaded or be partially threaded. The diameter of the inner cylindrical surface 86 may range from 0.100 to 1.000 inch and is more preferably approximately 0.313 inches. The helmet mount engaging member 66 has a length extending from an outer surface 88 of the upper clamp arm housing 52 to the free end 76 which may range from 1.000 to 2.000 inches and more preferably is approximately 1.635 inches. Further, the first segment 70 has a length extending from the outer surface 88 of the housing 52 to the second segment 74 which may range from 0.100 to 1.000 inch and more preferably is approximately 0.850 inches, and the second segment 74 has a length extending from the first segment 70 to the free end 76 which may range from 0.100 to 1.000 inches and more preferably is approximately 0.785 inches. While the helmet mount engaging member 66 is shown having two segments of varying diameter, it is understood that additional or fewer segments and varying diameters may be used without departing from the overall scope of the present invention. For example, the helmet mount engaging member 66 may have a uniform cross section which mates with a helmet mount 30 that contacts the upper clamp arm 36, wherein the upper clamp arm may have a flat area or shoulder forming a contact surface.

The helmet mount engaging member 66 receives or carries the helmet mount 30 or novelty helmet mounting portion. The helmet mount 30 is free to spin or rotate on the helmet mount engaging member 66 about central axis 32. To this end, the helmet mount 30, as shown in FIGS. 7-8, has an inner channel 90. The channel 90 has an inner cylindrical surface 92. The channel 90 also has a first channel section 94. The first channel section 94 has an opening 96 at a lower surface 98 of the helmet mount 30 and extends inward into the helmet mount 30 toward a second channel section 100. The first channel section 94 has a first inner diameter. The second channel section 100 has an opening forming a fastening receptor 102 and extends inward into the helmet mount 30 and toward the first channel section 94. The second channel section 100 has a second inner diameter which is smaller than the first inner diameter. The first inner diameter may approximate or be slightly larger than the first outer diameter of the helmet mount engaging member 66. To this end, the first inner diameter may range from 0.500 to 1.500 inch and more preferably is approximately 0.930 inches. The second inner diameter may correspond to or may approximate the second outer diameter of the helmet mount engaging member 66. The second inner diameter may range from 0.100 to 1.000 inch and more preferably is approximately 0.500 inches. The first and second channel sections 94, 100 are open to and in communication with one another forming inner channel 90. At the intersection of the first and second channel sections 94, 100, the variance between the first inner diameter and second inner diameter forms a downwardly facing shoulder 104. As seen in FIGS. 7 & 8, when the helmet mount 30 is located in position on the helmet mount engaging member, the downwardly facing shoulder 104 rests upon and engages upwardly facing shoulder 80 of the helmet mount engaging member 66.

Helmet mount 30 is formed, generally, of a solid material. The helmet mount 30 may also be formed of a rigid material. In a preferred embodiment, the helmet mount 30 is formed of a plastic, and may be machined or molded into the requisite form. Alternative materials, however, such as but not limited to metal, which accomplish the same purpose would not depart from the overall scope of the present invention. To this end, additional components, such as, but not limited to bearings for rotation, may be used to modify certain components or materials to accomplish the same purposes. Furthermore, while the helmet mount 30 described herein is described and illustrated with a number of faceted components, more rounded or curved features may be acceptable.

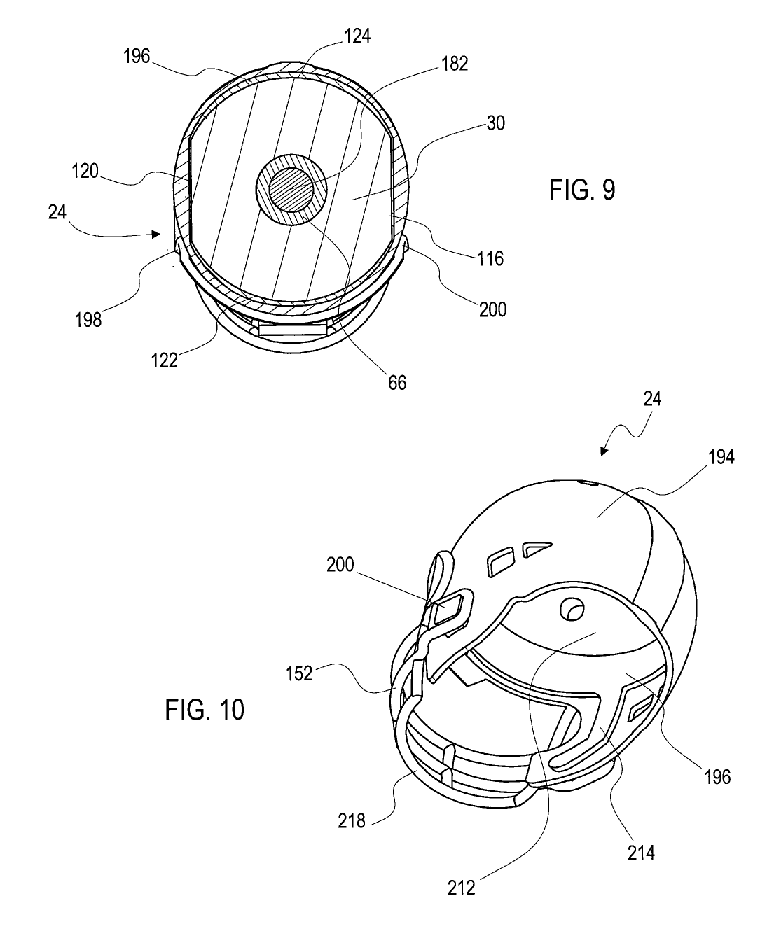

The helmet mount 30, as shown in FIGS. 3, and 6 through 9, has an external geometry that mates with portions of the internal geometry of a novelty helmet 24, such as the novelty football helmet 24 shown in the figures, engaging in an interference fit. To this end, the helmet mount 30 is formed by engaging surfaces that engage the helmet joined to clearance portions that provide clearance for placement or removal of the helmet 24. In particular, the helmet mount 30 has a mid section 106 spacing a lower section 108 and an upper conical section 110. The mid section 106 has a first side segment 112 and a second side segment 114. The first side segment 112 has first planar sidewall 116 formed by a substantially planar surface 118 (see FIG. 3). The second side segment 114 has second planar sidewall 120 formed by a substantially planar surface substantially identical to the substantially planar surface 118. Spanning between first and second planar sidewalls 116, 120 are first and second arcuate walls 122, 124 (FIG. 9). Below the first and second planar sidewalls 116, 120 are first and second inwardly tapered sidewalls 126, 128. The first and second inwardly tapered sidewalls 126, 128 may each be formed by a substantially planar surface 130. The inwardly tapered sidewalls 126, 128 taper inward toward the central axis 32 from a first position 132 corresponding to for example the lower edge of planar surface 118. A substantially vertical rib 134 extends along the surface of the mid section 106 at a rear portion 136 of the helmet mount 30 (FIGS. 6 & 7). Between the rib 134 and the first and second inwardly tapered sidewalls 126, 128 on each of the first and second side segments 112, 114 is a substantially identical recessed sidewall 138. The front portion 142 of the mid section 106 has a substantially vertical rib 144. At the lower end 146 of the substantially vertical rib 144 is a protrusion 148. The protrusion 148 extends outward from an imaginary plane 150 extending from the substantially vertical rib 144 and is shaped to approximate a portion of the novelty helmet 24. In FIG. 7, the shape of the protrusion 148 matches a portion of the geometry or curvature of a facemask 152 carried by the novelty helmet 24. The protrusion 148 further forms a portion of the lower section 108 of the helmet mount 30. The lower section 108 of the helmet mount 30 includes sloped lower surface 98 which slopes upwardly from the base 154 of the protrusion 148 to the base of the substantially vertical rib 134 carried on the rear portion 136 of the helmet mount 30. The upper conical section 110 has a base section 156 with a first diameter corresponding to the diameter of the mid section 106. The base 156 of conical section 110 may also include an upper portion 158 of the first and second planar sidewalls 116, 120 carried by the mid section 106. The conical section 110 further includes an upper section 160 which has a diameter smaller than the diameter of the base 156. The diameter of the base 156 may range from 1.000 to 2.000 inches and more preferably is approximately 1.570 inches. The diameter of the upper section 160 may range from 0.500 to 1.500 inches and is more preferably approximately 1.020 inches. The upper conical section 110 forms an upper surface 162 that has a fastening receptor portion 164.

The helmet mount 30 according to the foregoing arrangement may be construed, when viewed at the front or rear as may be shown for example in FIG. 8, as having first and second symmetrical halves 166, 168 which are formed by a dividing line extending vertically along the central axis 32 and in a plane extending into and out of the page. These symmetrical halves 166, 168 form mirror images of each other. The helmet mount 30 according to the foregoing arrangement may also be construed, when viewed from the side, as may be shown for example in FIG. 7, as having first and second asymmetrical sections 170, 172 which are formed by a dividing line extending vertically along the central axis 32 and in a plane extending into and out of the page.

The fastening receptor portion 164 of the helmet mount 30 has an aperture 174 opening onto the upper surface 162 of the helmet mount 30. The aperture 174 is formed by one or more sidewalls and in FIGS. 5-8 is a cylindrical sidewall 176 extending into the helmet mount 30. The fastening receptor portion 164 also has a lower wall 178 with an upwardly facing surface 180. The fastening receptor portion 164 and aperture 174 are sized to receive a fastener 182, such as a bolt or screw. The lower wall 178 of the fastening receptor portion 164 has an aperture 184 sized to receive the fastener 182 and aligned with the opening or aperture 84 in the helmet mount engaging member 66.

As shown in FIGS. 5-9, the fastener 182 is a bolt or screw having a head 186 adapted to be received on the upwardly facing surface 180 of the fastening receptor 164. The head 186 also has a tool engaging surface 188 for mating with, for example, a wrench, screw driver or other device adapted to operate the fastener 182. The fastener 182 also has a shaft 190. The shaft 190 extends from the head 186 and has a length which approximates the length or depth of the inner channel 90 in helmet mount engaging member 66. More specifically, the shaft 190 has a length ranging from 1.0 inches to 2.0 inches and is more preferably approximately 1.5 inches. The shaft 190 may have a thread 191 or have a ring or groove or other mechanism for securing the fastener in position in the aperture. Correspondingly, the inner channel 90 may include a mating thread 193 or mechanism to secure the bolt. The shaft 190 optionally carries a washer 192. The washer 192 may have an aperture 194 sized to approximate the diameter of the shaft 190, as well as an outer diameter sized to fit within the fastening receptor portion 164 of the helmet mount 30 and to retain the helmet mount in place on the helmet mount engaging member 66.

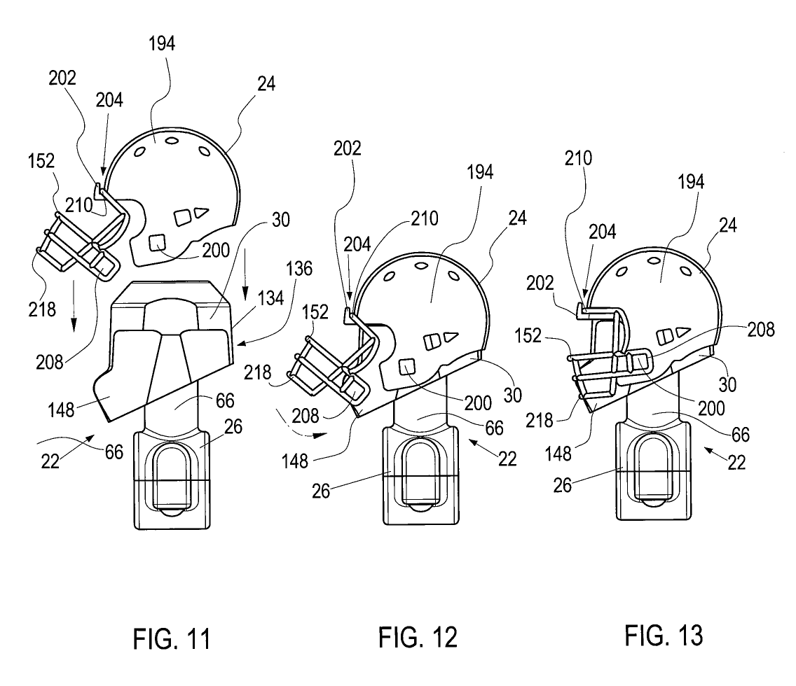

As indicated herein, the helmet mount 30 is adapted to carry and interchangeable novelty helmets 24. A novelty helmet suitable for use with the steering wheel spinner assembly 22 is available from RIDDELL® (Riddell Inc., Rosemont, Ill.). The example novelty helmet 24 illustrated in the figures is a football helmet. The helmet 24 may include any team logo, color or insignia thereon. The helmet 24 may further include any form or type of facemask meeting the purposes provided herein. It is contemplated that the assembly described herein may be used or otherwise modified to fit with alternative novelty headwear, such as a hats, baseball helmets, race car driver helmets, or other suitable novelty devices. The novelty helmet is generally formed of a lightweight plastic or composite material, but alternative materials may be suitable for the purposes provided. The novelty helmet 24 has a helmet shell 194, a separable facemask 152, and a compliant liner 196. The helmet shell 194 includes first and second posts 198, 200 located on each side of the shell 194, as well as a trough 202 with an upward facing groove 204 above the helmet face opening 206. The separable facemask 152 is removably attached to the helmet shell 194. More specifically, the first and second posts 198, 200 on the helmet shell 194 each extend into a mating opening 208 (see FIG. 11) in the facemask 152, and the upper bar 210 of the facemask 152 is carried by the trough 202 on the helmet shell 194. While only mating opening 208 and corresponding post 200 is illustrated in the figures, an additional mating opening identical to mating opening 208 is provided for post 198. The compliant liner 196 provides a compliant fit with the helmet mount 30 and may be a closed-cell foam liner. As shown in FIG. 10, the liner 196 is attached on the interior 212 of the helmet shell 194 and surrounds at least a portion of the helmet shell 194. FIG. 10 illustrates, in perspective view, the liner 196 located on the helmet. The liner 196 is attached by adhesive or other suitable devices or compounds. The liner 196 may further include a lower arm 214 or pair of arms which approximate the shape of the face opening 206 in the helmet shell 194. While only a single arm 214 and a portion of the liner 196 are shown in the figures, an additional arm and additional liner material may be attached in the areas not viewable in the figures.

The novelty helmet 24 which is positioned on the helmet mount 30, as shown in FIGS. 1, and 7 through 9, forms numerous contacts with the helmet mount lower, mid and upper sections 106, 108, 110. The surfaces of first planar sidewall 116 and second planar sidewall 120 each press against or otherwise contact the liner 196 on the sides of the helmet 24, or may instead engage the helmet shell 194. The first and second arcuate walls 122, 124 correspond in shape with the curvature of the helmet shell 194. The inwardly tapered sidewalls 126, 128, similarly, correspond to the shape of the helmet shell 194. As can be seen in FIG. 8, the mid section 106 which includes the first and second planar sidewalls 116, 118, is wider than the lower section 108 of the helmet mount 30. The substantially vertical rib 134 at a rear portion of the helmet mount 30, as seen in FIG. 7, engages or presses against the liner 196, and may engage or otherwise press against the helmet shell 194. The base 156 of the upper conical section 110 may also contact the helmet shell 194. The inward tapered surface 162 of the conical section 110 may correspond to or allow for the curvature of the helmet shell 194. The upper portion 160 of the conical section 110 may be positioned a distance below the helmet shell 194 or may be in contact with the helmet shell 194.

An upper portion 216 of the substantially vertical rib 144 at the front the helmet mount 30 engages or presses against the liner 196, or alternatively the helmet shell 194. The protrusion 148, adjacent the vertical rib 144 contacts, presses against, or engages the facemask 152. As shown in FIG. 7, the protrusion 148 slopes downwardly and inwardly toward central axis 32 of the spinner assembly 22 similar to the curvature of the facemask 152. The protrusion 148 is adapted to non-permanently retain the novelty helmet 24 and support a portion of the novelty helmet against compression while the novelty helmet is grasped during use of the steering wheel spinner assembly The form of the protrusion 148 creates an increased overall width of the lower section 108 of the helmet mount 30 above the lower surface 98 of the helmet mount 30, which secures novelty helmet 24 rigidly in position for operational use and prevents removal, vertically, from the helmet mount 30 without disengaging the facemask 152 from the helmet shell 194. The protrusion 148 shape, which corresponds to the shape of the facemask supports the facemask against compression.

In a preferred method of assembling steering wheel spinner assembly 22, the helmet mount 30 is positioned on the helmet mount engaging member 66 by inserting the helmet mount engaging member 66 into the channel 90 in the helmet mount 30. The helmet mount 30 is carried in position on the helmet mount engaging member 66 by the engagement of the upwardly and downwardly facing shoulders 80, 104, and the cylindrical inner surface 92 of the channel 90 with fastener 182. The helmet mount 30 freely rotates in this position. More specifically, the helmet mount engaging member 66 has a central axis 32 extending away from the clamp assembly 26. The helmet mount 30 rotates about the central axis 32. The helmet mount 30 is further secured in place on the helmet mount engaging member 66 by the fastener 182 which is received in the aperture 184 and 84 at the free end 76 of the helmet mount engaging member 66. The fastener 182 is inserted into fastening receptor portion 164 of the helmet mount 30 and into the apertures 184, then into the channel 90 in the helmet mount engaging member 66 and secured or otherwise tightened into position. The washer 192 may further secure the helmet mount 30 in position. For example, the lower wall 178 of the fastening receptor portion 164 of the helmet mount 30 at its upward facing surface 180 forms a shoulder which contacts the washer 192. The washer 192, which is larger than the aperture 184 in the fastening receptor portion 164, secures the helmet mount 30 in position on the helmet mount engaging member 66. In addition to washer 192, an optional locking device, such as but not limited to a locking washer (not shown), may be added to the fastener to lock the fastener in position. The fastener is tightened and permits rotation about the central axis 32.

The steering wheel spinner assembly 22, in one example, may be secured or attached to a steering wheel 28 by operation of the clamp assembly 26. In particular, the lower clamp arm 34 and upper clamp arm 36 may be separated as shown in FIG. 3. The upper clamp arm 36 is placed over a steering wheel 28 such that a portion of the steering wheel 28 is received within the recess 54 of the upper clamp arm housing 52. The lower clamp arm 34 is aligned with the upper clamp arm 36 and placed over the steering wheel 28 such that a portion of the steering wheel 28 is received within the recess 46 of the lower clamp arm housing 44. One or more fasteners 40, 42 are then secured to the clamp arms 34, 36 by insertion into the apertures or receptors 40, 50, 56, 58 in the housings 44, 52. Once the steering wheel spinner assembly 22 is oriented in a operational position, an example of which is shown in FIG. 2, the fasteners 40, 42 may be tightened or otherwise secured to lock or engaging the clamp assembly 26 in position and restrict or prevent movement of the clamp assembly on the steering wheel 28.

In an additional preferred method of assembly, the helmet mount engaging member 66 may be integrally formed with the upper clamp arm 36 as seen by reference to FIGS. 7 & 8, and to this end may be, for example, an integrally molded device. Alternatively, the helmet mount engaging member 66 may be attached to the upper clamp arm housing 52, such as by screw, bolt, adhesive, or other suitable means which may be sufficient to rigidly and securely hold the helmet mount engaging member 66 in position on the upper clamp arm 36 during use. Likewise, the first and second segments 70, 74 may be integrally formed as illustrated in FIGS. 7 & 8, such as may be accomplished by molding, or may be separate structures secured together in position.

In FIGS. 11-13, the attachment of a novelty helmet 24 to a spinner assembly 22 to form assembly 20 in one preferred embodiment is shown. The novelty helmet 24, which may have a separable or partially separable facemask 152, is positioned such that the helmet 24 is located above the helmet mount 30 and the facemask 152 is aligned with the protrusion 148 of the helmet mount 30. To attach the novelty helmet 24, the facemask 152 is partially separated from the helmet shell 194. In particular, the mating openings 208 in the facemask 152 are separated from the first and second posts 198, 200 on the helmet shell 194 while the upper bar 210 is retained and rotated within trough 202. The facemask 152 can be disengaged from the helmet by elastically deforming it laterally and disengaging it from the two posts 198, 200 on the sides of the helmet 24, then rotating the facemask 152 toward the top of the helmet. Rotation of the facemask 152 causes the lower portion of the facemask 152 to be swung outward and upward away from the helmet shell 194 about the upper bar 210. The novelty helmet 24 is then lowered into position on the helmet mount 30. The novelty helmet 24 is secured or frictionally engaged by the interference fit of the helmet shell 194, and in particular the liner 196 carried within the helmet shell 194, and the helmet mount 30. The novelty helmet 24 and liner 196 press against the surfaces and sidewalls of the helmet mount 30 as previously described. The facemask 152 is then rotated into its engaged position, as shown in FIG. 12, by rotating the lower portion 218 of the facemask 152 downward and toward the helmet mount 30 about the upper bar 210. The facemask 152 is engaged with the helmet shell 194 by attaching the mating openings over the first and second posts 198, 200 on the helmet shell 194. Simultaneously, the facemask 152 is tightly engaged with, or pulled against, or otherwise pressed against the protrusion 148 on the helmet mount 30 forming an interference fit, frictionally securing the facemask 152 in position as shown in FIG. 13. The novelty helmet 24 is rigidly secured in this position due to the interference fit.

The steering wheel spinner assembly 22 enables novelty helmets 24 to be interchanged so that different helmets may be may be used with the assembly. When desired, a user may replace or interchange the novelty helmet 24 with a different novelty helmet by disengaging the facemask 152 from the attached helmet shell 194 such as discussed herein, removing the novelty helmet 24 by lifting the helmet from the helmet mount 30 and subsequently attaching an alternative or the same novelty helmet according to the previously described method.

In operation, a user may grasp the novelty helmet 24 which is mounted on the helmet mount 30 of the spinner assembly 22 and may rotate the helmet and mount about the central axis 32. The steering wheel 28 may also be moved by the application of force in the desired direction on the attached steering wheel spinner with interchangeable novelty helmet 20.

A steering wheel spinner assembly with interchangeable novelty helmet 20 provides various advantages over traditional steering wheel spinner assemblies. The steering wheel spinner assembly 22 incorporates geometric features that enable a commonly available product, namely, a novelty helmet 24, which may otherwise by unsuitable for use in a steering wheel spinner application due to a lack of structural capacity, to be installed onto the helmet mount 30 of the spinner and serve as the spinning knob portion of the assembly. The mating of the helmet mount 30 and the novelty helmet 24, including the interference fit within the helmet shell 194, and the protrusion 148 that engages the facemask 152, enables the use of a commonly available novelty helmet. As the engagement and securement of the novelty helmet 24 to the helmet mount 30 is an interference fit, the novelty helmet 24 is sufficiently secured to retain the helmet in place on the helmet mount 30 during operation, but is not permanent and does not require modification of the novelty helmet 24 to install. Furthermore, the steering wheel spinner assembly 22 has a helmet mount 30 which is formed to support a load or otherwise resist compression force placed upon the attached novelty helmet 24, thereby securing an otherwise fragile or semi-fragile device. The form of the helmet mount 30 includes a protrusion 148 that forms an increased width of the helmet mount 30, securing and supporting such a novelty helmet 24 rigidly in position for operational use. The shape of the protrusion also supports the facemask against compression when placed on the helmet mount. The protrusion 148 therefore provides support to the facemask 152 which may otherwise be compressed and disengage from the helmet while the installed helmet is grasped with the operator's hand during use of the steering wheel spinner assembly with interchangeable novelty helmet 20.

The steering wheel spinner assembly 22 further enables novelty helmets 24 to be interchanged so that different helmets may be may be used with the assembly. In this regard, the steering wheel spinner assembly 22 described herein provides for the releasable attachment of a novelty helmet 24, allowing an operator to customize the device.

Although various representative embodiments of this invention have been described above with a certain degree of particularity, those skilled in the art could make numerous alterations to the disclosed embodiments without departing from the spirit or scope of the inventive subject matter set forth in the specification and claims. All directional references, including but not limited to, upper, lower, upward, downward, left, right, leftward, rightward, top, bottom, above, below, vertical, horizontal, clockwise, counterclockwise, axis, central, and the like are only used for identification purposes to aid the reader's understanding of the embodiments of the present invention, and do not create limitations, particularly as to the position, orientation, or use of the invention unless specifically set forth in the claims. Joinder references (e.g., attached, coupled, connected) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to preferred embodiments, persons skilled in the art will recognize that changes may be made in form and detail without departing from the spirit and scope of the invention.

What is claimed is:

1. A novelty helmet mounting device carried by a receiving element, the novelty helmet mounting device comprising a novelty helmet mounting portion which mates with and engages a novelty helmet in an interference fit such that the novelty helmet mounting portion is adapted to receive and interchange multiple novelty helmets, the novelty helmet mounting portion adapted to non-permanently retain the novelty helmet and having a protrusion that supports a portion of the novelty helmet against compression while the novelty helmet is grasped during use of the steering wheel spinner assembly.

2. The novelty helmet mounting device of claim 1, wherein the receiving element carrying the novelty helmet mounting device is adapted to permit the novelty helmet mounting device to freely rotate about a central axis extending along the receiving element.

3. The novelty helmet mounting device of claim 2, wherein the receiving element has a steering wheel attachment assembly for securing the novelty helmet mounting device to a steering wheel.

4. The novelty helmet mounting device of claim 1, further comprising a novelty helmet mounted to the novelty helmet mounting portion, the novelty helmet being a football helmet.

5. The novelty helmet mounting device of claim 4, wherein the novelty helmet has a separable facemask.

6. A steering wheel spinner assembly comprising a steering wheel clamp assembly having a clamp and a receiving element; a novelty helmet mounting device carried by the receiving element such that the novelty helmet mounting device may freely rotate about a central axis extending along the receiving element, the novelty helmet mounting device having a novelty helmet mounting portion which mates with and engages a novelty helmet in an interference fit.

7. The steering wheel spinner assembly of claim 6, wherein the novelty helmet mounting portion has a protrusion adapted to support the novelty helmet against compression while the novelty helmet is grasped during use of the steering wheel spinner assembly.

8. The steering wheel spinner assembly of claim 6, wherein the novelty helmet mounting device is adapted to receive and interchange multiple novelty helmets.
